(19) United States
(12) Patent Application Publication
(10) Pub. No.: US 2004/0104510 A1
(43) Pub. Date: Jun. 3, 2004

(54) Method for manufacturing insert mold product

(76) Inventors: Takayuki Ito, Aichi-ken (JP); Toshihiko Asaya, Aichi-ken (JP); Norio Otani, Aichi-ken (JP)

Correspondence Address: POSZ & BETHARDS, PLC, 11250 ROGER BACON DRIVE, SUITE 10, RESTON, VA, 20190, US

(21) Appl. No.: 10/679,353

(22) Filed: Oct. 7, 2003

(30) Foreign Application Priority Data
Nov. 28, 2002 (JP) 2002-345444

(51) Int. Cl. B29C 45/14

(52) U.S. Cl. 264/259; 15/1

(57) ABSTRACT

A method for manufacturing an insert mold product using an insert member has machining step for machining the insert member using a machining assistant; a cleaning step for removing the machining assistant and foreign matter from the insert member, which foreign matter includes swarf created in the machining step; and an insert molding step for coating at least part of the surface of the insert member with a molding material. This prevents degradation in the quality of the product.

### BACKGROUND OF THE INVENTION

The present invention relates to a method for manufacturing an insert mold product.

Some vehicle steering wheels are manufactured through insert molding. A typical steering wheel has a core, or an insert member. On the rim of the core, a resin layer (for example, a urethane resin layer) is formed. On the surface of the resin layer, a film layer of mold coating made of light resistant surface protection material is formed. The thickness of the mold coating is, for example, 5 μm.

A steering wheel is typically manufactured, for example, through one of the following two methods.

In the first method, a material for mold coating is applied to the surface of the cavity of an opened mold with, for example, a spray gun, thereby forming a mold coating layer. Thereafter, the mold is closed with a core located at a predetermined position in the mold. The cavity is then filled with urethane resin to perform a conventional insert molding. This forms a resin layer.

An example of the second method is disclosed, for example, in Japanese Patent No. 2746024. In the second method, a mold is closed with a core located at a predetermined position in the mold. Thereafter, the pressure in the cavity is lowered with a vacuum pump. While the pressure in the cavity is being lowered, a solution for mold coating is introduced into the cavity to form a mold coating layer on the surface of the cavity. Thereafter, the cavity is filled with urethane resin to perform a conventional insert molding, thereby forming the resin layer.

The core is made, for example, through, for example, casting. In this case, fins are created on the cast core. To remove the fins, the core is, for example, subjected to, for example, shot blasting. The core has threaded holes to fix, for example, an airbag apparatus and a horn switch. The threaded holes are formed through cutting. Shot blasting and cutting are performed prior to insert molding even if fins and threaded holes are exposed and not covered by urethane resin.

When cutting the core, cutting lubricant is used. Swarf, such as separated from fins, and powder generated in the shot blasting, and shavings generated in the cutting can adhere to the core by the adhesion of the cutting lubricant. If a core with adhered swarf is used for forming a steering wheel through one of the above listed methods, the steering wheel will have the following drawbacks.

In the first method, when the core is located at the predetermined position in the mold, swarf adhered to the surface of the core can fall onto the mold coating layer on the surface of the cavity. If insert molding is performed with swarf on the mold coating layer, the manufactured steering wheel will have the swarf either between the resin layer and the mold coating layer or in the vicinity of the boundary of the resin layer and the mold coating layer. Since the mold coating layer is extremely thin, remaining swarf degrades the feel of gripping of the steering wheel.

In the second method, when the core is located at the predetermined position in the mold, swarf adhered to the surface of the core can fall onto the surface of the cavity. If the cavity is filled with the solution in this state, the swarf remains in or on the mold coating layer, which is formed after the filling of the solution. Remaining swarf degrades the feel of gripping of the steering wheel. Also, the remaining swarf can be seen on the surface of the steering wheel, which degrades the appearance of the steering wheel.

### SUMMARY OF THE INVENTION

Accordingly, it is an objective of the present invention to provide a method for manufacturing an insert molding product, which method prevents degradation in the quality of the product.

To achieve the above object, the present invention provides a method for manufacturing an insert mold product using an insert member. The method includes machining step for machining the insert member using a machining assistant; a cleaning step for removing the machining assistant and foreign matter from the insert member, which foreign matter includes swarf created in the machining step; and an insert molding step for coating at least part of the surface of the insert member with a molding material.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view illustrating a vehicle steering wheel according to one embodiment of the present invention;

FIG. 2 is a flowchart showing a procedure for manufacturing a core;

FIG. 3 is a front view illustrating a cleaning apparatus used in a cleaning process;

FIG. 4 is a schematic side view showing the cleaning apparatus;

FIG. 5 is a cross-sectional view taken along line 5-5 of FIG. 3;

FIG. 6 is a schematic view illustrating a manufacturing apparatus of a vehicle steering wheel;

FIG. 7 is a cross-sectional view a box and a mold of the manufacturing apparatus; and

FIG. 8 is flowchart showing a procedure for manufacturing the vehicle steering wheel.

### DETAILED DESCRIPTION OF THE PREFERRED EMBODIMENTS

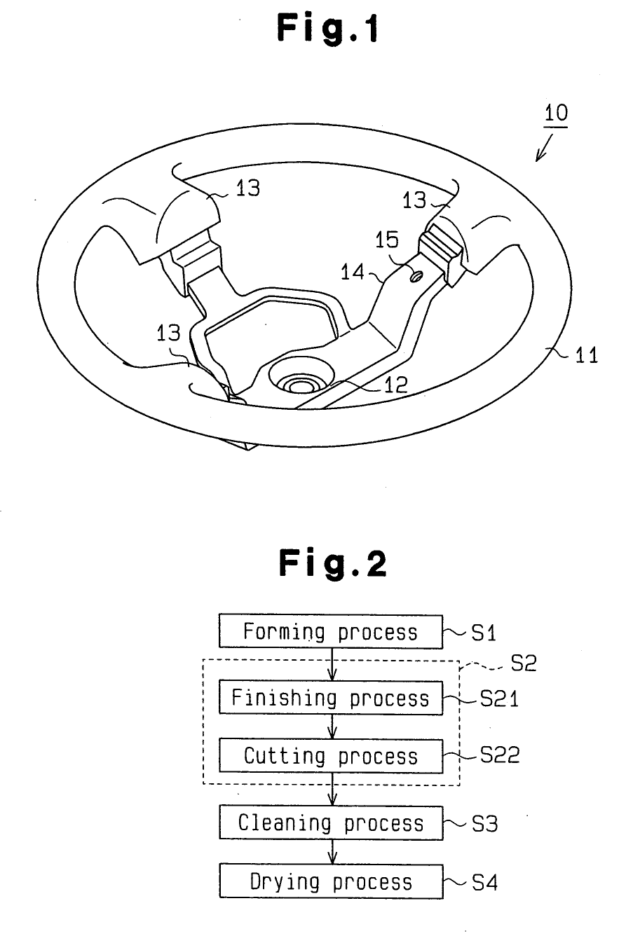

One embodiment of the present invention will now be described with reference to FIGS. 1 to 8.

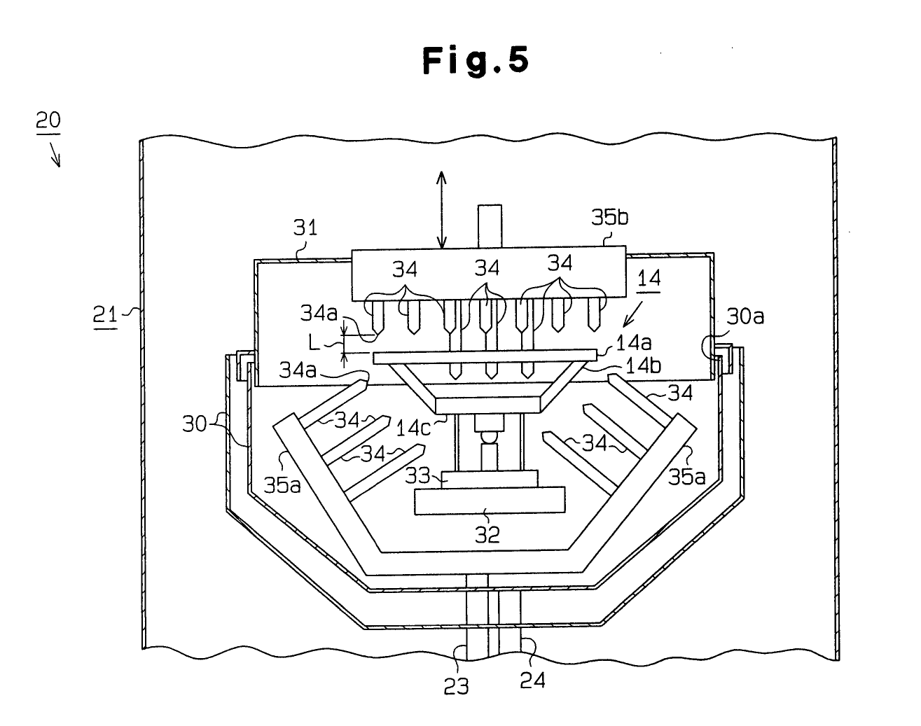

As shown in FIG. 1, an insert molded product, which is a vehicle steering wheel 10 in this embodiment, is manufactured by insert molding an insert member, which is previously formed into a predetermined shape. In this embodiment, the insert member is a core 14. The core 14 includes a ring portion 14a, a boss portion 14c, and spoke portions 14b (see FIG. 5). In this embodiment, the number of the spoke portions 14b is three. The spoke portions 14b couple the ring portion 14a with the boss portion 14c (see FIG. 5). The entire surface of the ring portion 14a of the core 14 is coated with a mold layer made of a molding material such as polyurethane to form a ring 11 of the steering wheel 10. Part of the surface of each spoke portion 14b is coated with the molding material for forming spokes 13 of the steering wheel 10. That is, the steering wheel 10 has the ring 11, a boss 12, and spokes 13. The number of the spokes 13 is three in this embodiment. The spokes 13 couple the ring 11 with the boss 12. A light resistant coating (mold coating layer) is formed on the surface of the mold layer. The coating protects the surface of the mold layer.

A procedure for manufacturing the core 14 will now be described with reference to FIG. 2.

In a forming process of step S1, the core 14, which has the ring portion 14a, the spoke portions 14b, and the boss portion 14c, is formed. In this embodiment, the core 14 is formed through casting. The core 14 may be formed through processes other than casting.

Then the process proceeds to a machining process of step S2. The machining process of step S2 includes a finishing process of step S21 and a cutting process of step S22. In step S21, fins formed on the core 14 in step S1 are removed. In this embodiment, the core 14 is subjected to, for example, shot blasting in step S21. Then the process proceeds to the cutting process of step S22. In step S22, threaded holes 15 (see FIG. 1) are formed in the steering wheel 10. The threaded holes 15 are used for fixing an airbag apparatus and a horn switch (neither is shown) to the steering wheel 10. The cutting process is performed while supplying machining assistant, or cutting lubricant, to portions of the core 14 that are being cut. As the cutting lubricant, water emulsion type, which can be diluted with water and has affinity for water, is widely used to reduce the load on the environment. In the cutting process, the cutting lubricant that is diluted with water is used.

Even if the fins and the threaded holes 15 are at positions that are not covered by the molding material, the shot blasting process and the cutting process are performed prior to an insert molding process (described below) to prevent the mold layer and the coating layer from being damaged.

The cutting lubricant used in step S22 collects on the surface of the core 14, and adhesive components in water composition and oil component of the cutting lubricant cause the removed fins and the particles of the shot blasting created in step S21 and the shavings created in S22 to be adhered to the surface of the core 14.

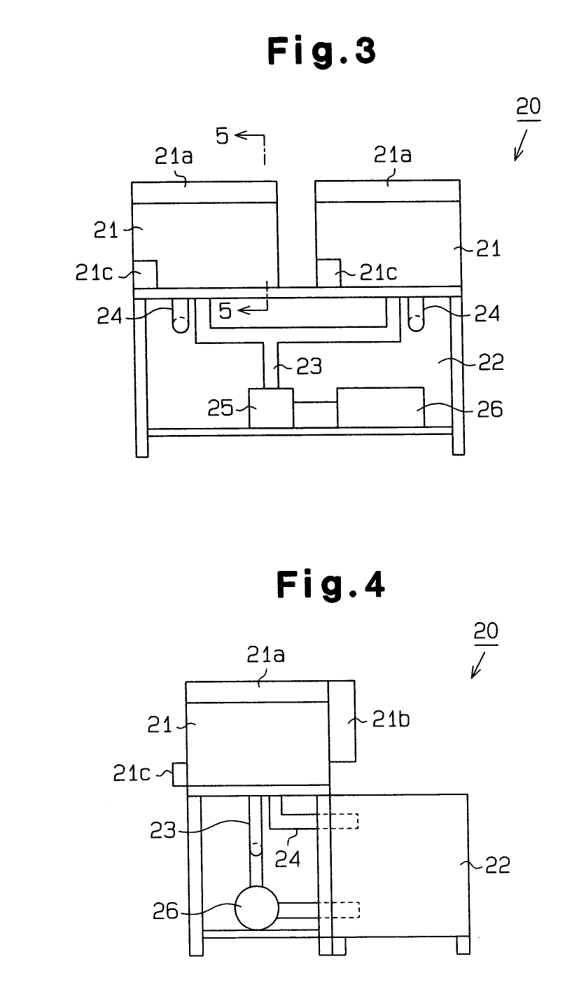

Thus, in this embodiment, a cleaning process of step S3 is performed to remove the cutting lubricant and foreign matter adhered to the surface of the core 14 that includes swarf created in the machining process, a cleaning process of step S3 is performed. In the cleaning process of the core 14 in step S3, a cleaning apparatus 20 shown in FIGS. 3 to 4 is used. The cleaning apparatus 20 injects cleaning agent to the core 14.

As shown in FIGS. 3 and 4, the cleaning apparatus 20 includes cleaning portions 21, a tank 22, a supply pipe 23, and drain pipes 24. Each cleaning portion 21 accommodates the core 14. The tank 22 stores the cleaning agent. The supply pipe 23 connects each cleaning portion 21 2 to the tank 22. The supply pipe 23 is connected to a pump 25 for sending the cleaning agent in the tank 22 to the cleaning portions 21. A motor 26 is connected to the pump 25 to activate the pump 25.

Each cleaning portion 21 has an opening on the top surface through which the core 14 placed in the cleaning portion 21. The opening of each cleaning portion 21 is opened and closed with a door 21a. Each door 21a is coupled to the corresponding cleaning portion 21 and is moved vertically by a cylinder 21b. Each cleaning portion 21 has a switch 21c for operating the cleaning apparatus 20.

As shown in FIG. 5, each cleaning portion 21 accommodates a cleaning bath 30 having an upper opening 30a and a lid 31 for closing the opening 30a. The lid 31 is moved vertically with the associated door 21a.

Each cleaning bath 30 accommodates a slide table 32, a receiving jig 33 located on the slide table 32, and nozzles 34. In this embodiment, the number of the nozzles 34 is sixteen. The slide table 32 is displaced by a predetermined distance in the cleaning bath 30. The receiving jig 33 is engaged with the core 14. Each nozzle 34 injects the cleaning agent to the core 14.

Some of the nozzles 34 are attached to a first fixing member 35a fixed to the cleaning bath 30. The other nozzles 34 are attached to a second fixing member 35b fixed to the lid 31. The fixing members 35a, 35b are connected to the supply pipe 23 (see FIG. 3) and permit the cleaning agent stored in the tank 22 to flow.

The nozzles 34 are arranged along the outer shape of the core 14, which is engaged with the receiving jig 33. Specifically, the nozzles 34 are arranged along the ring portion 14a, the spoke portions 14b, and the boss portion 14c of the core 14.

The distance L between an outlet 34a of each nozzle 34 and the surface of the core 14 along the injecting direction of the cleaning agent is between 10 mm and 500 mm inclusive. The range of the distance L is preferably between 10 mm and 100 mm inclusive, and more preferably between 30 mm and 40 mm inclusive.

In the cleaning process of step S3, the range of the pressure of the cleaning agent injected by each nozzle 34 is between 0.2 MPa and 0.5 MPa inclusive. The range of the pressure is preferably between 0.2 MPa and 0.4 MPa inclusive, and more preferably, between 0.25 MPa and 0.35 MPa inclusive.

In the cleaning process of step S3, the range of the injecting time of the cleaning agent injected by each nozzle 34 is between two seconds and ten seconds inclusive. The range of the injecting time is preferably between four seconds and eight second inclusive, and more preferably between five seconds and six seconds inclusive.

If the distance L is greater than 500 mm, if the pressure is less than 0.3 MPa, or if the injecting time is less than two seconds, cleaning effect of the cleaning agent is not sufficient and foreign matter adhered to the core 14 cannot be satisfactorily removed. To the contrast, if the distance L is less than 10 mm or if the pressure is more than 0.2 MPa, the injection of the cleaning agent is concentrated in narrow areas on the core 14. In this case, it is difficult to evenly clean the entire core 14. If the injecting time exceeds two seconds, the manufacturing time of the core 14 is extended, which increases the cost.

In the cleaning process of step S3, a fluid containing substance for dissolving or dispersing the adhesive component in the cutting lubricant is used. In this embodiment, water is used as the fluid.

The reason why water is used for the cleaning agent will now be explained.

Experiments were conducted using the cores 14 that had been subjected to the machining process of step S2. Specifically, the experiments were conducted for confirming to what extent shavings and shot blast particles can be removed by the following five removing methods. In the experiments, five to ten cores 14 were prepared for each method, and whether shavings and shot blast particles remained on each core 14 after performing each method was visually evaluated. If no shavings or shot blast particles were found, the core 14 was determined to be acceptable. If shavings or shot blast particles were found, the core was determined to be defective. In this manner, the percent defective was checked for each comparison example.

In the method according to the above embodiment, water was injected onto the core 14 after the machining process of the step S2 for cleaning the core 14. An injection apparatus having a single injection nozzle was used, and cleaning was manually performed by a user. The cleaning time was one minute.

In a comparison example 1, the core 14, which had been subjected to the machining process, was cleaned by injecting naphthenic cleaning agent (Naphthesol). The injecting apparatus, the cleaning method, and the cleaning time of this example were the same as those of the above embodiment.

In a comparison example 2, the core 14, which had been subjected to the machining process, was cleaned by injecting the same cleaning lubricant as used in the machining process. The injecting apparatus, the cleaning method, and the cleaning time of this example were the same as those of the above embodiment.

In the comparison example 3, air was blown to the core 14, which had been subjected to the machining process. In this comparison example, an injection apparatus having a single injection nozzle was used, and air was blown manually by a user. The blowing time was one minute.

In the comparison example 4, the surface of the core 14, which had been subjected to the machining process, was scrubbed with a steel scrub brush.

The results of these comparison examples will now be described with reference to chart 1. In chart 1, ∘ represents a case where the percent defective was less than 1%, Δ represents a case where the percent defective was equal to or more than 1% and less than 10%, and × represents a case where the percent defective was in a range between 10% and 100% inclusive.

| | Removing | | Shot Blasting |
|---|---|---|---|
| | Method | Shavings | Particles |
| Embodiment | Water Cleaning | ∘ | ∘ |
| Comparison Example 1 | Naphthesol | x | x |
| Comparison Example 2 | Cutting Lubricant | Δ | x |
| Comparison Example 3 | Air Blow | x | x |
| Comparison Example 4 | Steel Scrub Brush | x | x |

In the Naphtesol cleaning of the comparison example 1, the percent defective regarding shavings was 50%, and the percent defective regarding shot blasting particles was 20%. This is because the naphthenic cleaning agent is capable of removing oil component in the cutting lubricant but is not effective to remove aqueous solution in the cutting lubricant. Therefore, aqueous solution remaining on the surface of the core 14 prevented shavings and shot blasting particles from being removed.

In the cutting lubricant cleaning of the comparison example 2, although the percent defective regarding shavings was relatively good 4%, the percent defective regarding shot blasting particles was 100%. This shows that relatively large foreign matter such as shavings was removed, while small foreign matter such as shot blasting particles was not removed.

In the air blow of the comparison example 3, the percent defective regarding shavings was 40%, and the percent defective regarding shot blasting particles was 40%. The results were therefore unsatisfactory.

In the scrubbing with a steel scrub brush of the comparison example 4, the percent defective regarding shavings was 50%, and the percent defective regarding shot blasting particles was 40%. The results were therefore unsatisfactory. Also, in the comparison example 4, scrubbing the surface of the core 14 with the steel scrub brush shaved the surface of the core 14 and created fine powder.

Compared to the comparison examples 1 to 4, in the water cleaning according to the embodiment, the percent defective was 0% for both shavings and shot blasting particles. That is, the results were satisfactory. The cutting lubricant used in the cutting process can be diluted with water and has affinity for water. Therefore, the aqueous solution of the cutting lubricant on the core 14 was dissolved with water injected in the cleaning process, and the oil component was dispersed. This reduces the adhesion of the aqueous solution and adhesive component of the oil component of the cutting lubricant on the core 14, and hinders shavings and shot blasting particles from being removed form the core 14. In this manner, water cleaning of the core 14 in the cleaning process effectively removes foreign matter collected on the core 14. Also, since water is inexpensive and has little load on the environment, using water as the cleaning agent is preferable.

As shown in FIG. 2, a drying process of step S4 is performed after the cleaning process of step S3. In the drying process, water on the core 14 is removed. In this embodiment, air is blown to the core 14 in the cleaning portion 21 of the cleaning apparatus 20. Thereafter, the core 14 is removed from the cleaning apparatus 20 and is left unattended half-day.

The core 14 is manufactured through the above processes. The core 14 thus produced is provided for manufacturing the steering wheel 10 by using a manufacturing apparatus 40 described below.

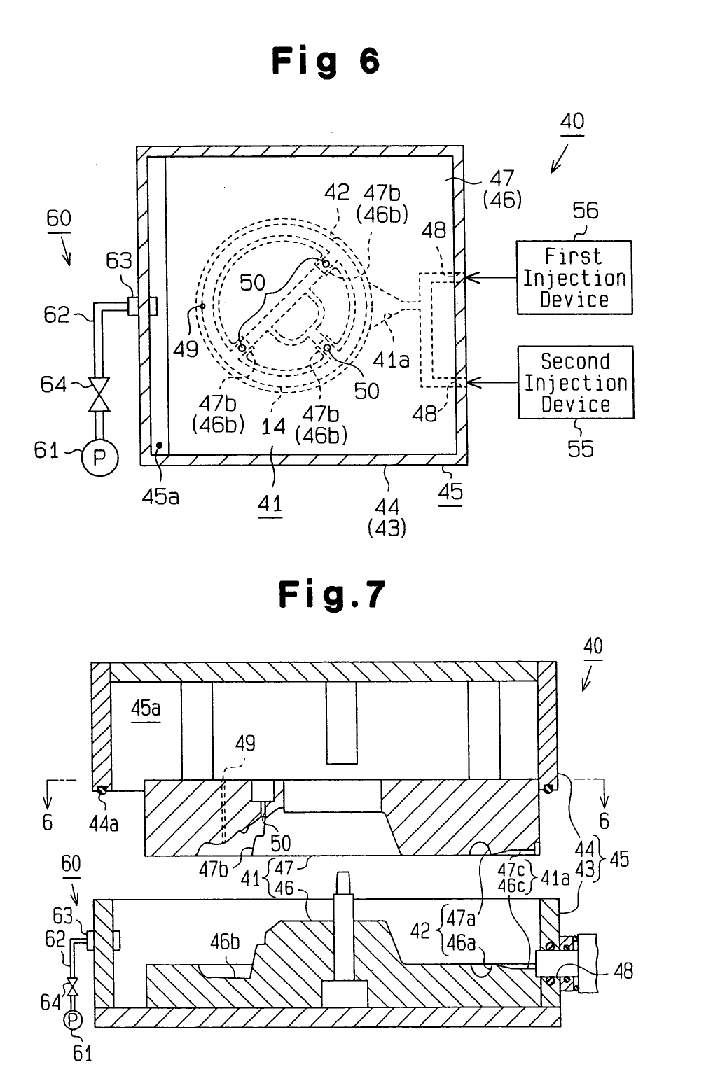

The manufacturing apparatus 40 will now be described with reference to FIGS. 6 and 7.

The manufacturing apparatus 40 includes a mold 41, first and second injection device 55, 56, and a decompression device 60. The first injection device 55 is used for forming the coating layer. The second injection device 56 is used for forming the mold layer. The decompression device 60 is used for decreasing the pressure in the cavity 42 of the mold 41.

The mold 41 is provided in a box 45 having a frame 43 and a lid 44. A stationary die 46 is located in the frame 43. The stationary die 46 functions as a part of the mold 41. A movable die 47 is located in the lid 44. The movable die 47 functions as a part of the mold 41. The lid 44 has a sealing member 44a at a position that contacts the frame 43.

When the lid 44 is moved upward relative to the frame 43 (moved upward as viewed in FIG. 6), and the frame 43 is separated from the lid 44, the movable die 47 is separated from the stationary die 46, or the mold 41 is opened. When the lid 44 is moved toward the frame 43 and contacts the frame 43, the movable die 47 contacts the stationary die 46, or the mold 41 is clamped. When the mold 41 is clamped, the frame 43, the lid 44, and the sealing member 44a seal seals the interior 45a of the box 45.

A first annular groove 46a is formed on the upper surface of the stationary die 46. A second annular groove 47a is formed in a part on the lower surface of the movable die 47 that corresponds to the groove 46a on the stationary die 46. First radial portions 46b extend from the first annular groove 46a toward the center of the annular groove 46a. The positions of the first radial portions 46b correspond to the spokes 13 of the steering wheel 10. Second radial portions 47b extend from the second annular groove 47a toward the center of the annular groove 47a. The positions of the second radial portions 47b correspond to the spokes 13 of the steering wheel 10. When the mold 41 is clamped, the annular grooves 46a, 47a define the cavity 42 for molding the steering wheel 10.

A first injection groove 46c is formed on the upper surface of the stationary die 46. The first injection groove 46c extends toward the outside of the box 45 from the first annular groove 46a and bifurcates halfway to the outside of the box 45. A second injection groove 47c is formed in a part on the lower surface of the movable die 47 that corresponds to the first injection groove 46c on the stationary die 46. The second injection groove 47c extends toward the outside of the box 45 from the second annular groove 47a and bifurcates halfway to the outside of the box 45. The injection grooves 46c, 47c define a gate 41a when the mold 41 is clamped. Two openings 48 that communicate with the outside are formed in the frame 43. The gate 41a is connected to the two openings 48. The cavity 42 of the mold 41 is connected to the outside of the box 45 through the gate 41a and the two openings 48.

A vent 49 having a small diameter and a through hole 50 having a diameter greater than that of the vent 49 are formed in the movable die 47. The vent 49 extends through the movable die 47 from the upper surface of the movable die 47 to the ceiling of the second annular groove 47a. The vent 49 is formed at a position that is farthest from the gate 41a. The through hole 50 extends through the movable die 47 from the upper surface of the movable die 47 to the ceiling of one of the second radial portions 47a. The through hole 50 may be omitted.

The first injection device 55 functions to inject coating material for forming the coating layer of the steering wheel 10 into the cavity 42 of the mold 41. The coating material contains molding material, pigment, and solvent. The molding material is a solid content, such as light-resistant a light resistant polyurethane. The solvent is a molding assistant, such as methyl ethyl ketone (MEK) and isopropyl alcohol (IPA).

On the other hand, the second injection device 56 injects molding material for forming the mold layer of the steering wheel 10 into the cavity 42 of the mold 41. The molding material contains a polyol component and a isocyanate component, which react with each other to form polyurethane.

The decompression device 60 has a vacuum pump 61. The vacuum pump 61 is connected to the frame 43 through a supply pipe 62 and a discharge pipe 63. A valve 64 is provided in the supply pipe 62. When manufacturing the steering wheel 10, the decompression device 60 decreases the pressure of the interior 45a of the box 45 and the pressure of the cavity 42 of the mold 41.

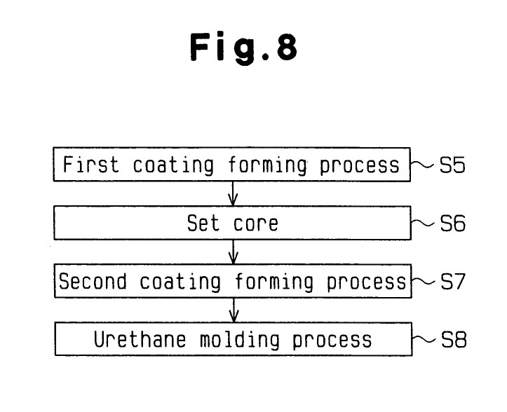

A procedure for manufacturing the steering wheel 10 using the manufacturing apparatus 40 will now be described with reference to FIG. 8. The steering wheel 10 is manufactured, for example, through the insert molding described below.

First in a first coating forming process of step S5, a mold release agent is applied to the surface of the first annular groove 46a of the stationary die 46 and the surface of the second annular groove 47a of the movable die 47 when the dies 46, 47 are open. Accordingly, a film of the mold release agent is formed on the surface of each of the annular groove 46a, 47a. The mold release agent is, for example, wax or silicone oil. The mold release agent prevents the molded steering wheel 10 from adhering to the mold 41, and facilitates removal of the steering wheel 10.

Subsequently in step S6, the core 14, which has been manufactured by the above described method, is set at a predetermined position in the stationary die 46. Then, the mold 41 is clamped. At this time, the lid 44 contacts the frame 43 and the box 45 is sealed.

Then, in a second coating forming process of step S7, a film of a mold coating material is formed on the film of the mold release agent.

In step S7, the first injection device 55 injects a predetermined amount of coating material into the cavity 42 of the mold 41 through the gate 41a. Thereafter, the vacuum pump 61 is activated to decrease the pressure of the interior 45a of the box 45 and the pressure of the cavity 42 of the mold 41. When the pressure in the cavity 42 is decreased to a predetermined pressure, the solvent in the coating material injected in the cavity 42 comes to a boil. Boiling of the solvent causes the molding material and the pigment to be evenly applied onto the surface of the cavity 42 (specifically, on the film of the mold release agent). The vaporized solvent is discharged to the outside of the box 45 through the vent 49, the through hole 50, and the decompression device 60. This dries the cavity 42, and forms a thin film of the mold coating material having an even thickness on the surface of the cavity 42.

Subsequently, in a urethane molding process of step S8, the mold layer is formed. In the urethane molding process, the second injection device 56 injects a predetermined amount of molding material into the cavity 42 of the clamped mold 41 through the gate. That is, a conventional urethane molding is performed. Thereafter, the mold 41 is opened to remove the steering wheel 10 in which the mold layer exists between the coating layer and the core 14.

This embodiment provides the following advantages.

(1) During manufacturing of the core 14, the core 14 is cleaned in the cleaning process (step S3) after the finishing process (see step 21 of FIG. 2) and the cutting process (step S22). These processes are performed prior to the insert molding process.

Therefore, when even foreign matter such as cutting lubricant and swarf (shavings and shot blasting particles) collect on the surface of the core 14 during the finishing process and the cutting process, the foreign matter is removed from the core 14 in the cleaning process. This prevents foreign matter from remaining in the mold layer and the coating layer of the molded steering wheel 10. Therefore, the steering wheel 10 of this embodiment is comfortably manipulated by a driver while the vehicle is running. Since the steering wheel 10 has a smooth surface, the appearance is prevented from deteriorating.

Particularly, in a case where the coating layer is formed using boiling of the solvent containing the coating material in the coating forming process (step S7 of FIG. 8), foreign matter collected on the core 14 falls when the solvent boils and is apt to move onto the surface of the cavity 42 (the film of the mold release agent). If the insert molding is performed in this state, fallen foreign matter is apt to remain on the surface of or in the vicinity of the surface of the steering wheel 10, which degrades the quality of the steering wheel 10.

In contrast to this, foreign matter is previously removed in the cleaning process of step S3 in this embodiment, the quality of the steering wheel 10 is reliably prevented from deteriorating.

(2) In the cleaning process, the core 14 is cleaned with water. In the cutting process, the cutting lubricant that has an affinity for water is used. Water is a fluid that is capable of dissolving or dispersing aqueous solution or adhesive component such as oil component in the cutting lubricant. Therefore, adhesive component in the cutting lubricant used in the machining process is dissolved or dispersed with water used in the cleaning process, thereby removing the adhesive component from the core 14. Accordingly, foreign matter such as swarf collected on the core 14 is removed with the adhesive component. Since water is inexpensive and widely available, and has little load on the environment, the manufacturing cost of the core 14 is reduced.

(3) The cleaning process is performed by injecting water to the core 14 with a predetermined pressure. Therefore, when cleaning the core 14 in the cleaning process, injected water intensely collides against the surface of the core 14, and the collided water effectively remove foreign matter collected on the core 14.

(4) The nozzles 34 are arranged substantially along the outer shape of the core 14 and inject water toward the core 14. Since a plurality of the nozzles 34 are used for cleaning the core 14, the time required for cleaning the core 14 is reduced. Also, since the nozzles 34 are arranged substantially along the outer shape of the core 14, the entire core 14 is evenly cleaned.

(5) After the cleaning process, the drying process (step S4 of FIG. 2) is performed for drying and removing water on the core 14. Therefore, for example, if water is used as a foaming agent and foamed in the urethane molding process (step S8 of FIG. 8), the foaming agent will not be excessive, and the foaming state of the coating layer of the steering wheel 10 will be optimized.

It should be apparent to those skilled in the art that the present invention may be embodied in many other specific forms without departing from the spirit or scope of the invention. Particularly, it should be understood that the invention may be embodied in the following forms.

In the cleaning process (step S3), the temperature of water used for cleaning the core 14 is arbitrarily determined.

In the cleaning process, if water that is heated to a temperature higher than an ordinary temperature is used, the ability of water to remove foreign matter is improved. Accordingly, foreign matter collected on the core 14 is readily removed. Also, heated water increases the temperature of the core at the end of the cleaning process, which permits the core 14 to be readily dried. Particularly, using steam to clean the core 14 will make these advantages remarkable.

The cleaning agent used in the cleaning process is not limited to water. The cleaning agent may be changed as necessary according to the machining assistant used in the machining process (step S2 of FIG. 2).

The cleaning agent may be a fluid that contains substance that dissolves, disperses, or adsorbs adhesive component in the machining assistant.

The cleaning agent is not limited to liquid, but may be gas or powder fluid.

The number, the arrangement, and the injection type of the nozzles 34 may be changed according to the shape and the size of the core 14.

In the cleaning process, the cleaning is not necessarily performed by the cleaning apparatus 20. For example, the core 14 may be immersed in a cleaning agent stored in a container to remove foreign matter collected on the core 14. In this case, moving the core 14 or stirring the cleaning agent permits foreign matter on the core 14 to be efficiently removed.

Processes performed in the machining process are not limited to the shot blasting process and the cutting process. As long as the machining is performed using an adhesive material (for example, processed oil of various types or water), the types, the number, and the order of processes may be arbitrarily determined.

For example, if using the core 14 with cleaning agent remaining on the surface in the insert molding process does not adversely affect the quality of the steering wheel 10, the drying process (step S4 of FIG. 2) may be omitted.

The types and the order of processes in the insert molding process (steps S5 to S8 of FIG. 8) are not limited to those described above. For example, when molding a leather covered steering wheel, which does not require the coating layer, the coating forming process (step S7 of FIG. 8) may be omitted.

The present invention may be applied to insert molded products other than the steering wheel 10. For example, the present invention may be applied to a method for manufacturing assist grips.

The present examples and embodiments are to be considered as illustrative and not restrictive and the invention is not to be limited to the details given herein, but may be modified within the scope and equivalence of the appended claims.

1. A method for manufacturing an insert mold product using an insert member, comprising:
a machining step for machining the insert member using a machining assistant;
a cleaning step for removing the machining assistant and foreign matter from the insert member, which foreign matter includes swarf created in the machining step; and
an insert molding step for coating at least part of a surface of the insert member with a molding material.

2. The method according to claim 1, wherein the insert molding step comprising:
an injecting step in which, with the insert member set in a cavity of a mold, for injecting at least one solution selected from the group consisting of a solution containing the molding material and a solution containing a molding assistant; and
a coating forming step, wherein the injected solution is boiled to form a coating on a surface of the cavity.

3. The method according to claim 1, wherein the cleaning step includes contacting the insert member with cleaning agent and removing the foreign matter.

4. The method according to claim 3, further comprising a cleaning agent removing step performed after the cleaning step, wherein, in the cleaning agent removing step, cleaning agent is removed from the insert member.

5. The method according to claim 3, wherein the cleaning step includes injecting the cleaning agent to the insert member.

6. The method according to claim 3, wherein the cleaning step includes using a cleaning apparatus that has a plurality of nozzles, wherein the nozzles are arranged substantially along an outer shape of the insert member, and injecting cleaning agent to the insert member.

7. The method according to claim 3, wherein the cleaning agent is a fluid containing a substance that dissolves, disperses, or adsorbs an adhesive component that causes the foreign matter to adhere to the insert member.

8. The method according to claim 7, wherein the cleaning step includes injecting the cleaning agent to the insert member at a predetermined pressure.

9. The method according to claim 7, wherein the machining assistant has a high affinity for water, and the cleaning agent is water.

10. The method according to claim 3, wherein the cleaning step includes using a cleaning agent that is heated to a temperature higher than an ordinary temperature.

11. The method according to claim 10, wherein the cleaning agent is steam.

12. The method according to claim 1, wherein the insert member is a core of a vehicle steering wheel.

13. A method for manufacturing an insert mold product using an insert member, comprising:
a machining step for machining the insert member using a machining assistant;
a cleaning step using a cleaning agent for removing the machining assistant and foreign matter from a surface of the insert member, which foreign matter includes swarf created in the machining step;
a drying step for removing cleaning agent from the surface of the insert member by drying the insert member after the cleaning step; and
an insert molding step for coating at least part of the surface of the insert member with a molding material.
